(19) United States
(12) Patent Application Publication
(10) Pub. No.: US 2014/0370982 A1
(43) Pub. Date: Dec. 18, 2014

(54) GAME INPUTTING DEVICE AND GAME CONTROLLING METHOD

(71) Applicant: Ozaki International Co., Ltd., New Taipei City (TW)

(72) Inventor: Keng-Yuan LIU, New Taipei City (TW)

(73) Assignee: Ozaki International Co., Ltd., New Taipei City (TW)

(21) Appl. No.: 14/089,077

(22) Filed: Nov. 25, 2013

(30) Foreign Application Priority Data
Jun. 17, 2013 (TW) 102121413

(51) Int. Cl. A63F 13/20

(52) U.S. Cl. CPC A63F 13/06
USPC 463/31

(57) ABSTRACT

A game inputting device and game controlling method related to a game inputting device includes a base, a plurality of game buttons, a detection module and a communication module. The base includes a body and a bracket disposed on the body. The bracket supports a handheld electronic-device standing on the base in a working state. The game buttons are disposed on the body of the base. A game image of the handheld electronic-device includes a plurality of rhythm points moving toward the game buttons with a rhythm speed. The detection module is electrically connected to the game buttons and generates a pressing signal in response to the pressing of the game buttons. The communication module sends a control message to the handheld electronic-device according to the pressing signal. The handheld electronic-device displays an interactive animation corresponding to the position of the pressed game button according to the control message.

### CROSS-REFERENCES TO RELATED APPLICATIONS

This non-provisional application claims priority under 35 U.S.C. §119(a) on Patent Application No. 102121413 filed in Taiwan, R.O.C. on 2013 Jun. 17, the entire contents of which are hereby incorporated by reference.

### BACKGROUND OF THE INVENTION

1. Technical Field

The disclosure relates to an inputting device, and particularly to a game inputting device and a game controlling method.

2. Related Art

Thanks to the developments of touch sensing technologies, many conventional electronic devices (for example, mobile phones) have touch screens assembled thereon. Therefore, many software manufacturers have designed many software interfaces and programs, which can be operated intuitionally, based on the characters of the touch screens. Particularly, the game software manufacturers have developed many touch games, which are novel and can be operated by touch-controlling the touch screen of the electronic device.

Even though the players can get experiences and entertainments from the touch games which is totally different from that from the conventional games due to the special operation of the touch games, some problems still comes, however. For example, when the user (player) touch-controls the screen to operate, the fingers or the palm of the user will shield parts of the screen; or, the user cannot conveniently use many fingers to touch-control the screen simultaneously with the limited region of the screen.

### SUMMARY

In view of this, the disclosure provides a game inputting device and game controlling method, which can solve the aforementioned problems contributed by the prior arts.

One invention concept of the disclosure provides a game inputting device cooperating with a handheld electronic-device. The handheld electronic-device has a screen for displaying a game image. The game inputting device includes a base, a plurality of game buttons, a detection module and a communication module. The base includes a body and a bracket disposed on the body. The bracket supports the handheld electronic-device standing on the base in a working state. The game buttons are disposed on the body of the base. The game image includes a plurality of rhythm points. Each of the rhythm points is moved toward the game buttons with a rhythm speed. The detection module is electrically connected to the game buttons so as to respond the pressing of the game button and generate a pressing signal. The communication module sends a control message to the handheld electronic-device according to the pressing signal. The handheld electronic-device displays an interactive animation on the game image corresponding to the position of the pressed game button according to the control message.

Another invention concept of the disclosure provides a game controlling method applicable for a handheld electronic-device and a game inputting device. The game controlling method includes disposing the handheld electronic-device on a base of the game inputting device, wherein the base includes a body and a plurality of game buttons disposed on the body; displaying a game image on the handheld electronic-device, wherein the game image includes a plurality of rhythm points, each of the rhythm points moves toward the game buttons with a rhythm speed; the game inputting device detecting if the game buttons are pressed; the game inputting device responding the pressing of the game buttons to generate a pressing signal; the game inputting device sending a control message to the handheld electronic-device according to the pressing signal; and the game inputting device displaying an interactive animation on the game image corresponding to a position of a pressed game button according to the control message.

As above, the game inputting device and game controlling method of the disclosure enables the user to play the game conveniently, so that the screen of the handheld electronic-device is not shielded. Besides, the receiving state and the working state of the game inputting device lead the game inputting device to be carried and operated conveniently. Furthermore, the game inputting device can notify the handheld electronic-device of the configuration of the game buttons actively, so that the game image displayed on the handheld electronic-device can be adjusted properly according to the game inputting device.

The detailed features and advantages of the disclosure are described below in great detail through the following embodiments, the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only and thus not limitative of the disclosure, wherein:

FIG. 1 is a schematic operational view for showing a game inputting device of a first embodiment of the disclosure is cooperating with a handheld electronic-device;

FIG. 2 is a schematic block diagram of the game inputting device of the first embodiment of the disclosure;

FIG. 3 is a schematic view for showing the game inputting device of the first embodiment of the disclosure is in a receiving state;

FIG. 4 is a schematic view for showing the game inputting device of the first embodiment of the disclosure is in a working state;

FIG. 5 is a schematic view for showing a game inputting device of a second embodiment of the disclosure is in a receiving state;

FIG. 6 is a schematic view for showing the game inputting device of the second embodiment of the disclosure is in a working state;

FIG. 7 is a schematic view for showing a game inputting device of a third embodiment of the disclosure is in a receiving state;

FIG. 8 is a schematic view for showing the game inputting device of the third embodiment of the disclosure is in a working state;

FIG. 9 is a schematic operational view for showing the game inputting device of the third embodiment of the disclosure is cooperating with the handheld electronic-device;

FIG. 10 is another schematic operational view for showing the game inputting device of the third embodiment of the disclosure is cooperating with the handheld electronic-device;

FIG. 11 is a schematic view for showing a game inputting device of a fourth embodiment of the disclosure is in a receiving state;

FIG. 12 is a schematic view for showing the game inputting device of the fourth embodiment of the disclosure is in a working state;

FIG. 13 is a schematic view for showing a game inputting device of a fifth embodiment of the disclosure is in a receiving state;

FIG. 14 is a schematic view for showing the game inputting device of the fifth embodiment of the disclosure is in a working state;

FIG. 15 is a schematic view for showing a game inputting device of a sixth embodiment of the disclosure is in a receiving state;

FIG. 16 is a schematic view for showing the game inputting device of the sixth embodiment of the disclosure is in a working state; and

FIG. 17 is a flow chart of a game controlling method of one embodiment of the disclosure.

### DETAILED DESCRIPTION

The contents described hereinafter are provided for those who are skilled in this art so that those who are skilled in this art can understand the substantial technical approaches efficiently. Therefore, the details of the methods, processes, structures and circuits known by skilled in this art are omitted for ensuring the contents can be totally realized by those skilled in this art.

It should be realized that, the phrase “one embodiment” mentioned hereinafter means that the combination of the described characters, structures or the features of this embodiment can be included in at least one of the implementation aspects of the disclosure. Wherein, the phrase “In one embodiment” may be related to many different embodiments which are compatible with each other.

Also, it should be realized that, when one member is disclosed to be “disposed on” or “connected to” another member hereinafter, one member can be directly disposed on or connected to another member, or an intermediate member can be disposed between one member and another member. On the contrary, when one member is “directly disposed on” or “directly connected to” another member, no intermediate member is disposed between one member and another member.

The spatial-relation terminological terms, for example, below, above, etc., are applied to describe the basic relationships between the members/features of the disclosure shown in the figures. It should be realized that, besides showing the orientational relationship of the members/features in the figures, the spatial-relation terminological terms also represents the orientational relationships of the members/features upon the disclosure is operating or corresponding to other devices. For instance, when the disclosure shown in the figure is flapped, the member which is below another member will become above said another member. Therefore, the exemplary terminological term “below” can represent “disposed above . . . ” or “disposed below . . . ”. Similarly, the disclosure shown in the figures can be presented by other orientations (like 90 degrees clockwise/counterclockwise rotation) corresponding to the operation state or receiving state of the disclosure.

Here, the phrase “and/or” includes any of, many of or all of the combinations of the listed terms. It should be realized that, the singular term “a/an” and “the” can also includes the plural condition, unless in the number of the member are clearly defined in this patent document. It should also be realized that, when the phrases “comprise(s)” and/or “include(s)” are applied in this patent document for disclosing a character, step, member and/or component, further character(s), step(s), member(s), component(s) and/or the combination thereof are not excluded from the disclosure.

The phrase “signally connected” mentioned in this patent document means two devices or members are connected with each other by means of wire communication (such as impulse control, universal serial bus (USB), wire networks or etc.) and/or wireless communication (such as blue tooth, wireless networks or etc.), so that signals (or messages) can be sent therebetween.

It should be realized that, the device(s) shown in the figures are schematic only, the actual. outline of the device are not limited by the outline of the device shown in the figures, and the scope of the disclosure is not limited thereto.

Hereinafter, the terminologies (including the technical terminologies and the scientific terminologies) have the same meaning as refer to the understanding of those who are skilled in the art, unless otherwise prescribed. It should be realized that, the terms (for example, terms defined by the dictionaries) should be elucidated as the meaning which is consistent with the related technologies of the disclosure; the terms should not be elucidated ideally or specifically unless the terms are clearly limited thereto.

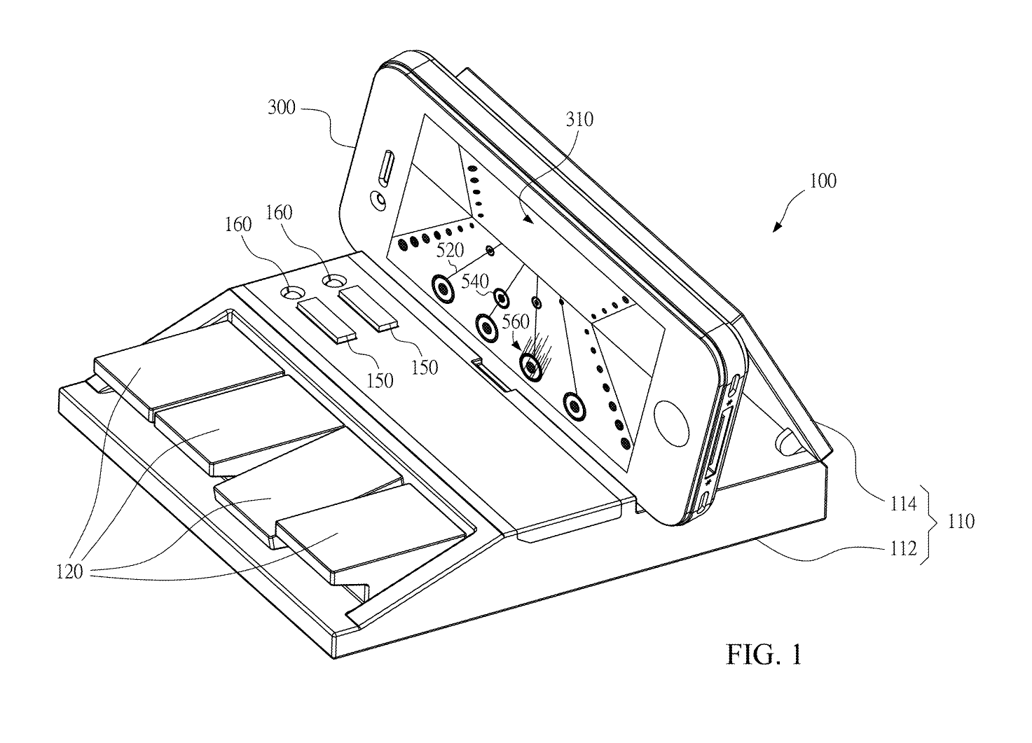

FIG. 1 is a operational schematic view of a game inputting device 100 of a first embodiment of the disclosure is cooperating with a handheld electronic-device 300. Please refer to FIG. 1, the handheld electronic-device 310 has a screen 310 for displaying a game image. The game inputting device 100 is provided to cooperate with the handheld electronic-device 300 for a user to play the game (or, called as the video game). Here, the handheld electronic-device 300 can be a mobile phone, a smart phone, a personal digital assistant (PDA), a tablet PC, a digital camera, a digital photo frame etc. The screen 310 can be a LCD screen with touch function or a LCD screen without touch function, and the LCD screen can be a light-emitting diode (LED) screen or an organic light-emitting diode (OLED) screen.

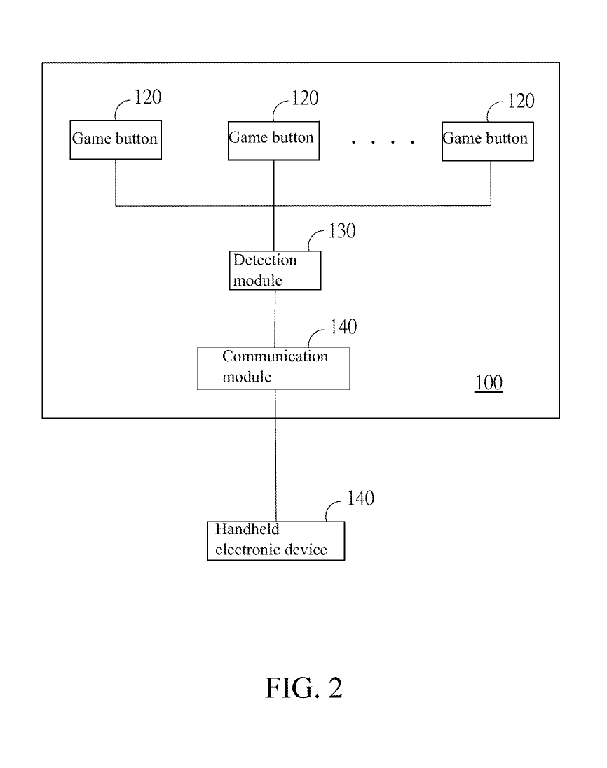

FIG. 2 is a schematic block diagram of the game inputting device 100 of the first embodiment of the disclosure. Please refer to FIG. 1 and FIG. 2, the game inputting device 100 includes a base 110, a plurality of game buttons 120, a detection module 130 and a communication module 140. The detection module 130 is electrically connected between the game buttons 120 and the communication module 140. The communication module 140 is signally connected to the game inputting device 100. The base 110 includes a body 112 and a bracket 114 disposed on the body 112. The bracket 114 supports the handheld electronic-device 300 standing on the base 110 in a working state. The detection module 130 and the communication module 140 can be assembled inside the body 112. The game buttons 120 are disposed on the body 112 (that is, disposed on the outer surface of the body 112). Here, the game buttons 120 are disposed at the front side of the body 112 of the base 110, and the bracket 114 is disposed at the rear side of the body 112 of the base 110 in the working state. In this embodiment, each of the game buttons 120 is closely disposed to the adjacent game buttons 120.

As shown in FIG. 1, the game image presented by the screen 310 includes a plurality of rhythm points 540. Each of the rhythm points 540 is moved toward the game buttons 120 with a rhythm speed. Here, the rhythm speed of each of the rhythm points 540 can be the same or different from each other. Besides, the moving path of each of the rhythm points 540 can be linear, but embodiments of the disclosure are not limited thereto, the moving path of each of the rhythm points 540 can be a curve, a broken line or the combination thereof, as well. Here, the game image is consisting of a plurality of continuously displaying frames. Since the positions of each of the rhythm points 540 are different in different frames, the user can see the game image is a dynamic image via the phenomenon of the persistency of vision. In other words, the rhythm points 540 are dynamic graphics.

In one embodiment, the game image further includes a plurality of rhythm tracks 520 in which the number thereof is corresponding to the number of the game buttons 120. Here, the number of the game buttons 120 and that of the rhythm tracks 520 is four, but embodiments of the disclosure are not limited thereto; the number of the game buttons 120 and that of the rhythm tracks 520 can be alternated according to a game software corresponding to the game inputting device 100. The head terminals of the rhythm tracks 520 are far from the game buttons 120 respectively and the tail terminals of the rhythm tracks 520 are near to the game buttons 120 respectively. Furthermore, the rhythm tracks 520 can be linear, but embodiments of the disclosure are not limited thereto, the rhythm tracks 520 can also be curves, broken lines or the combination thereof. Each rhythm point 540 is moved from the head terminal of each corresponding rhythm track 520 toward the tail terminal of each corresponding rhythm track 520 with the rhythm speed. Based on this, the user can press down the game button 120 when the corresponding rhythm point 540 is moved to the tail. terminal of the rhythm track 520 along with the music of the game. At this time, the detection module 130 responds the pressing of the game buttons 120 to generate a pressing signal. And then, the communication module 140 sends a control message to the handheld electronic-device 300 according to the pressing signal. Thereinafter, the handheld electronic-device 300 displays an interactive animation 560 on the game image corresponding to the position of the pressed game button 120 according to the control message. Here, the interactive animation 560 is an illuminative graphic, but embodiments of the disclosure are not limited thereto. The user can check whether the timing for pressing the game button 120 is correct or not via the displaying of the interactive animation 560, so that the entertainments of the game is improved.

Here, the rhythm tracks 520 can also be dynamic graphics.

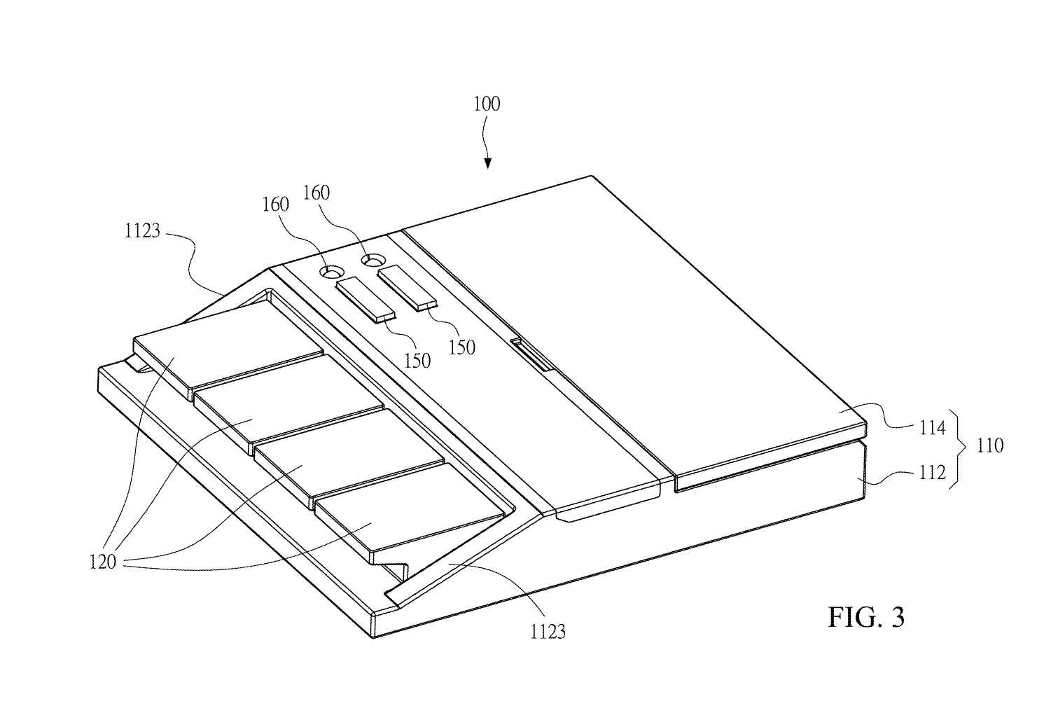

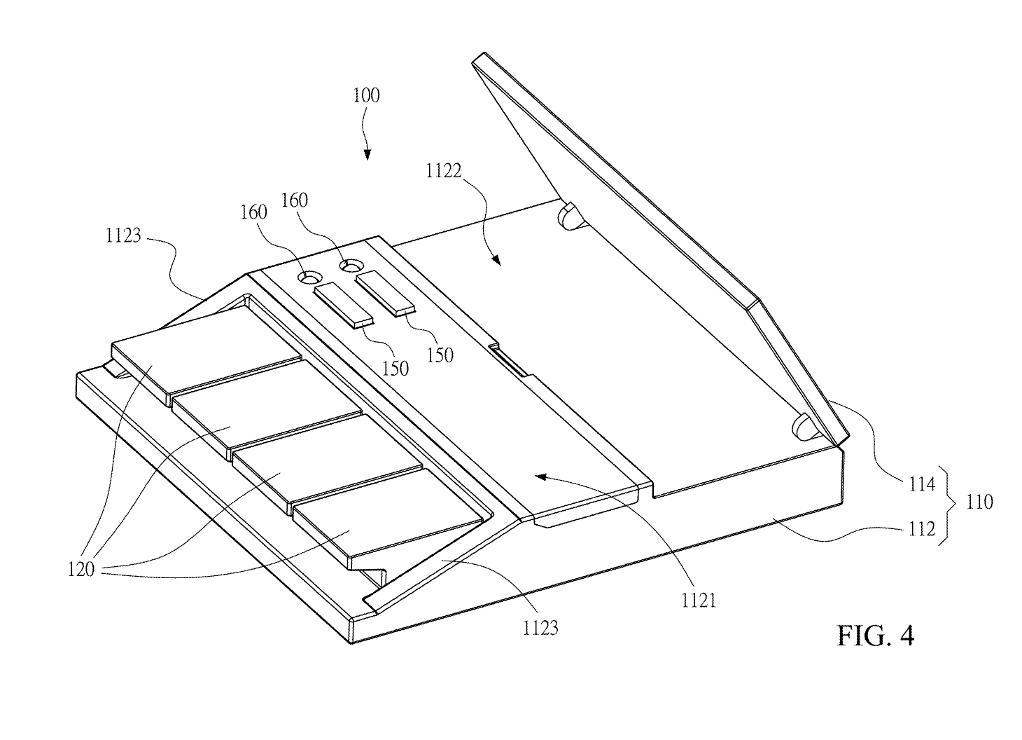

FIG. 3 is a schematic view for showing the game inputting device 100 of the first embodiment of the disclosure is in a receiving state. FIG. 4 is a schematic view for showing the game inputting device 100 of the first embodiment of the disclosure is in the working state.

As referring to FIG. 3 and FIG. 4, the bracket 114 is formed as a plate, and the body 112 is approximately formed a rectangular bulk structure. The bracket 114 is pivotally connected to one side of the body 112. Based on this, the bracket 114 can be attached on the outer surface of the body 112 in the receiving state; an inclined angle is defined between the bracket 114 and the outer surface of the body 112 in the working state, so that the screen 310 of the handheld electronic-device 300 is faced to the game buttons 120 (namely, faced to the user) and is slightly tilted toward a direction far from the body 112 (namely, tilted upward).

As shown in FIG. 4, a top plane 1121 of the body 112 has a recessed region 1122 located at the joints between the body 112 and the bracket 114. A recessed depth of the recessed region 1122 is substantially equal to the thickness of the bracket 114. Based on this, the bracket 114 and the body 112 form a flat upper surface in the receiving state, so that besides of being capable of storing conveniently, the beauty of the game inputting device 100 can be presented.

In one embodiment, the pivoting shaft of the bracket 114 for pivoting with the body 112 further has a resilient module (for example, a spring), so that a resilient force is applied to the bracket 114 and the bracket 114 is forced to the handheld electronic-device 300. Based on this, the handheld electronic-device 300 can be securely clamped between the bracket 114 and the body 112. In addition, the resilient module makes the bracket 114 closely attach on the surface of the body 112 in the receiving state, so that the bracket 114 does not swing freely and the damage of the bracket 114 can be avoided. Here, one end of the handheld electronic-device 300 is abutted against the side wall of the recessed region 1122 to prevent the handheld electronic-device 300 from sliding upon the resilient force is applied.

As shown in FIG. 4, the edge of the front side of the top plane 1121 of the body 112 (namely, the region on where the game buttons 120 are disposed) has an inclined plane 1123 for giving prominence to the game buttons 120, so that the user can notice the operating positions easily. Here, the outline of the game buttons 120 is similar to that of the keys of the piano or the electronic piano. The width/length ratio of the game buttons 120 is defined within 1:1 to 1:3.

As shown in FIG. 3, the game inputting device 100 further includes one or more controlling buttons 150 and one or more indicator lights 160 in which the number of the controlling buttons 150 is corresponding to that of the indicator lights 160. For example, the controlling button 150 can be the power button of the game inputting device 100 and the corresponding indicator light 160 displays whether the game inputting device 100 is turned on or turned off. The controlling button 150 can also be the connection button of the communication module 140, and the corresponding indicator light 160 displays the connection state of the communication module 140 (that is, whether the game inputting device 100 is cooperated with the handheld electronic-device 300 or not).

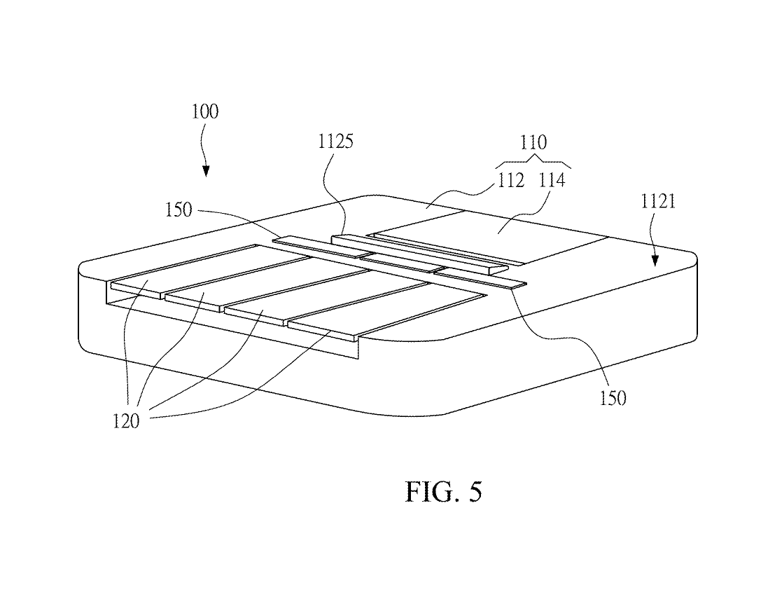

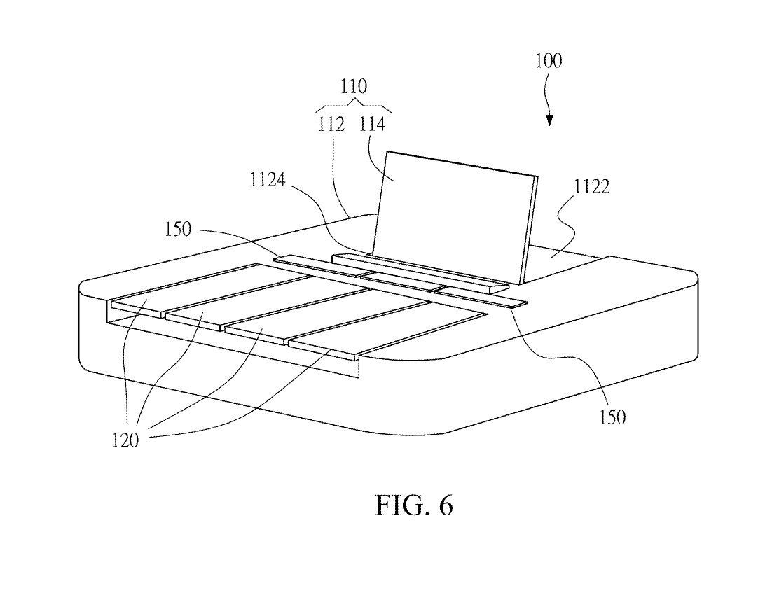

FIG. 5 is a schematic view for showing a game inputting device 100 of a second embodiment of the disclosure in a receiving state. FIG. 6 is a schematic view for showing the game inputting device 100 of the second embodiment of the disclosure in a working state.

The game inputting device 100 of the second embodiment is approximately similar to that of the first embodiment, except that the disposing of the bracket 114 which will be elucidated in detail later.

As referring to FIG. 5 and FIG. 6, the top plane 1121 of the body 112 has a recessed region 1122, the recessed depth of the recessed region 1122 is substantially equal to the thickness of the bracket 114. Based on this, the bracket 114 is parallel to the top plane 1121 and inserted into the recessed region 1122 in the receiving state so as to fill up the recessed region 1122. Here, each of the two sides of the recessed region 1122 has a slot (not shown) corresponding to the bracket 114, so that the bracket 114 does not separated from the body 112 in the receiving state. When the user wants to use the game inputting device 100, the user pulls the bracket 114 from the body 112 and assembles (inserts) the bracket 114 in a fastening portion 1124 of the body 112. Here, the fastening portion 1124 is substantially a recessed groove.

As shown in FIG. 5, the body 112 further includes an inclined seat member 1125 disposed on the top plane 1121 thereof. The inclined seat member 1125 is disposed near to the fastening portion 1124 and has an inclined top face. When the handheld electronic-device 300 is assembled on the fastening portion 1124, the adjacent two faces of the handheld electronic-device 300 (namely, the bottom face and the low portion of one side face of the handheld electronic-device 300) are attached to the bracket 114 and the inclined seat member 1125 respectively.

In the second embodiment, as shown in FIG. 5, the surfaces of the game buttons 120 is aligned with the top plane 1121 of the body 120, so that the game buttons 120 does not protruded out from the base 110 and damaged easily upon a foreign impact.

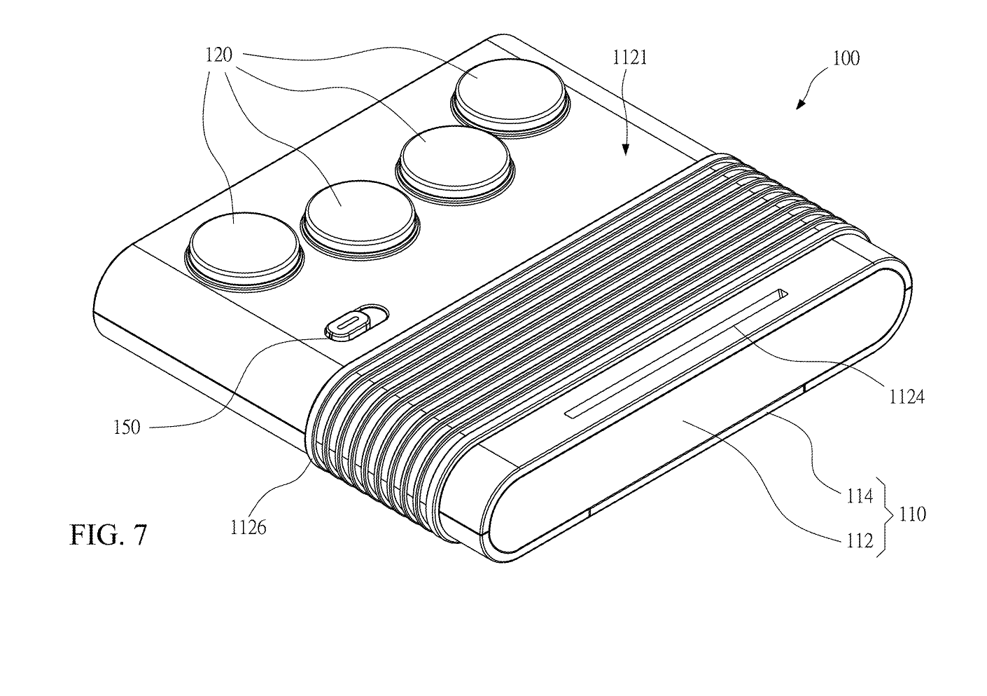

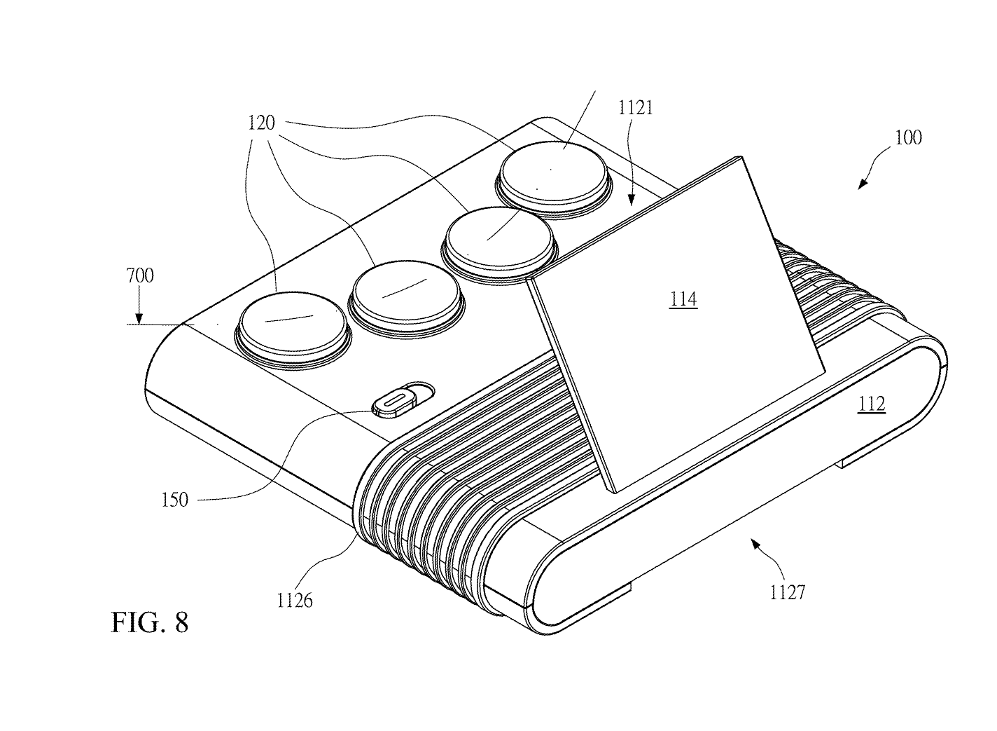

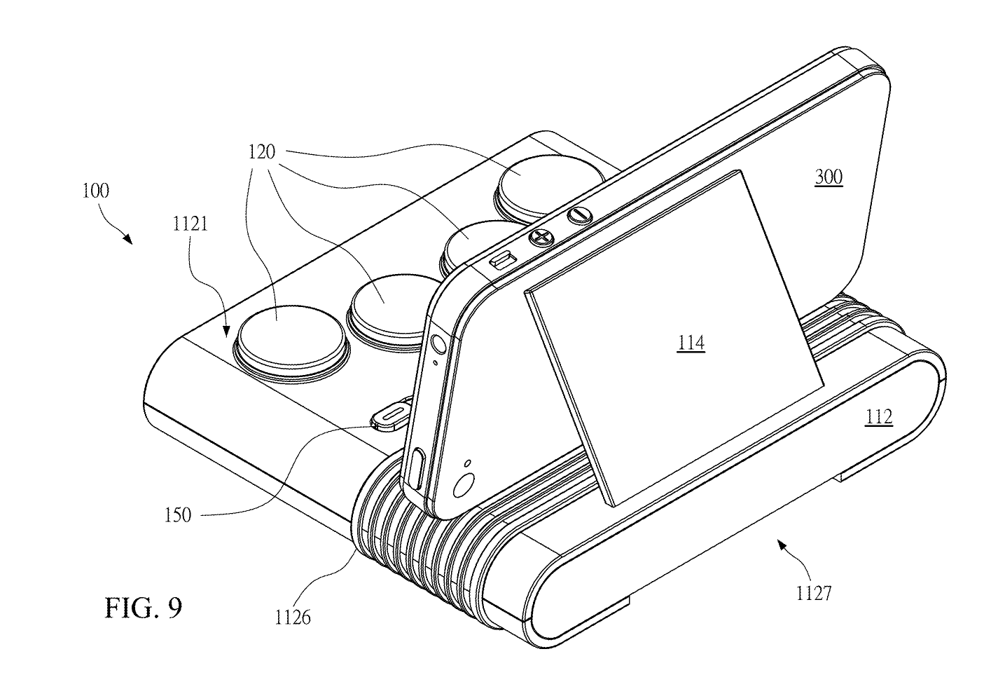

FIG. 7 is a schematic view for showing a game inputting device 100 of a. third embodiment of the disclosure is in a receiving state. FIG. 8 is a schematic view for showing the game inputting device 100 of the third embodiment of the disclosure is in a working state. FIG. 9 is a schematic operational view for showing the game inputting device 100 of the third embodiment of the disclosure is cooperating with the handheld electronic-device 300.

The game inputting device 100 of the third embodiment is approximately similar to that of the second embodiment, except that the received position of the bracket 114 in the received state which will be elucidated in detail later.

As referring to FIG. 7 and FIG. 8, the body 112 includes a breach 1127. The bracket 114 is detachably covered on the breach 1127 in the receiving state. Here, the bracket 114 can be inserted into the breach 1127 via buckling. The two sides of the bracket 114 and the two sides of the breach 1127 have grooves corresponding to each other to prevent the bracket 114 separating from the body 112 in the receiving state. Here, the breach 1127 is located at the plane of the body 112 opposite to the top plane 1121 of the body 112 (that is, the bottom plane). The body 112 includes a fastening portion 1124 disposed on the top plane 1121 thereof. The fastening portion 1124 is substantially a recessed groove. When the user wants to use the game inputting device 100, the user pulls out the bracket 114 from the bottom plane of the game inputting device 100 and inserts the bracket 114 into the fastening portion 1124. Based on this, the handheld electronic-device 300 is leaned against the bracket 114 and stands on the base 110 (as shown in FIG. 9).

As shown in FIG. 9, the base 110 further includes a plurality of skid-proof protruding ribs 1126 arranged side by side on the surface of the body 112. Here, the skid-proof protruding ribs 1126 are disposed around the body 112. The skid-proof protruding ribs 1126 are disposed adjacent to the fastening portion 1124, so that the handheld electronic-device 300 can stand on the skid-proof protruding ribs 1126. Especially, the handheld electronic-device 300 can stably stand on a bumpy surface formed by the skid-proof protruding ribs 1126 and the top plane 1121 of the body 112.

As shown in FIG. 8, the game buttons 112 are disposed along a parabola line 700, and the opening of the parabola line 700 is toward to the edge of the front side of the body 112. Based on this, the game buttons 112 are disposed corresponding to the lengths of the user's fingers, so that the user can operate the game buttons 112 ergonomically. Here, the game buttons 112 are embodied by rounded pressing structures.

As shown in FIG. 8, the controlling buttons 150 can be embodied by switching structures.

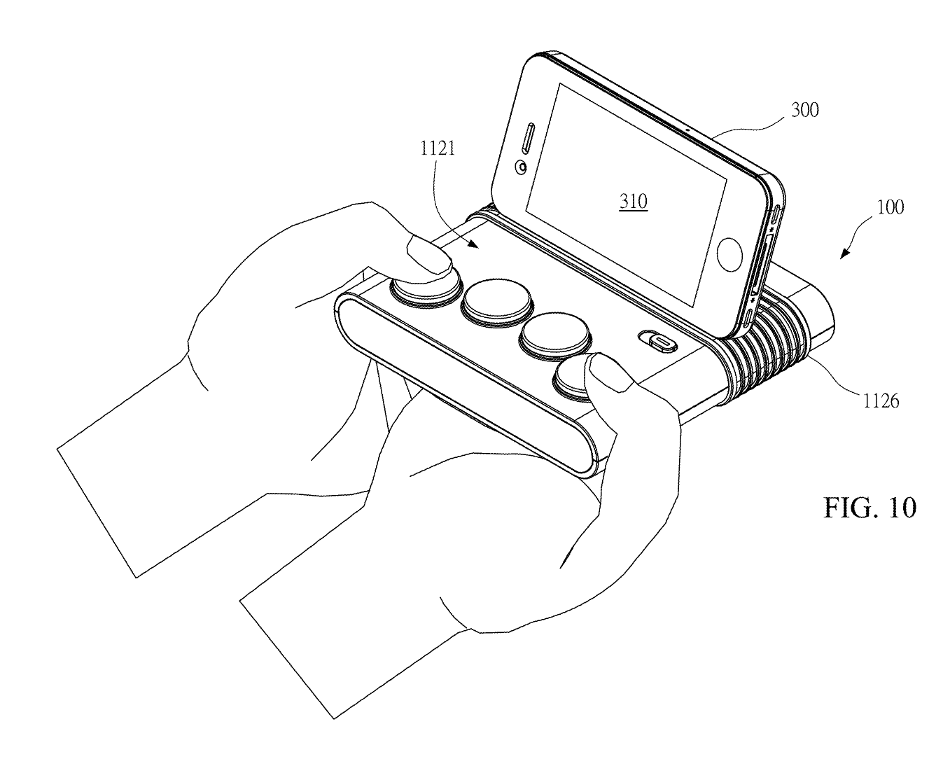

FIG. 10 is another schematic operational view for showing the game inputting device 100 of the third embodiment of the disclosure is cooperating with the handheld electronic-device 300. Here, besides of being operated on a platform (for example, on the desk), the game inputting device 100 can also be held by the user (as shown in FIG. 10).

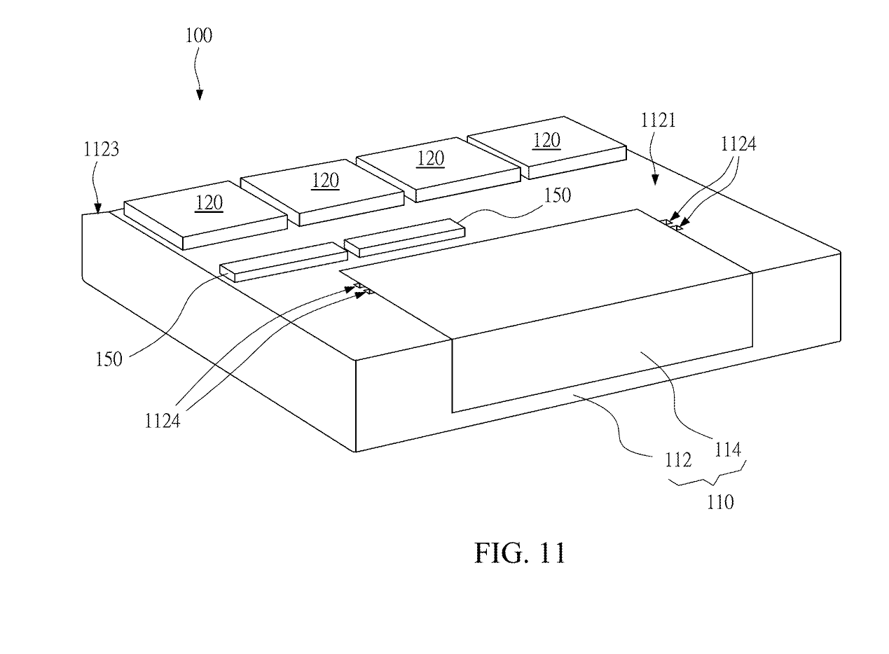

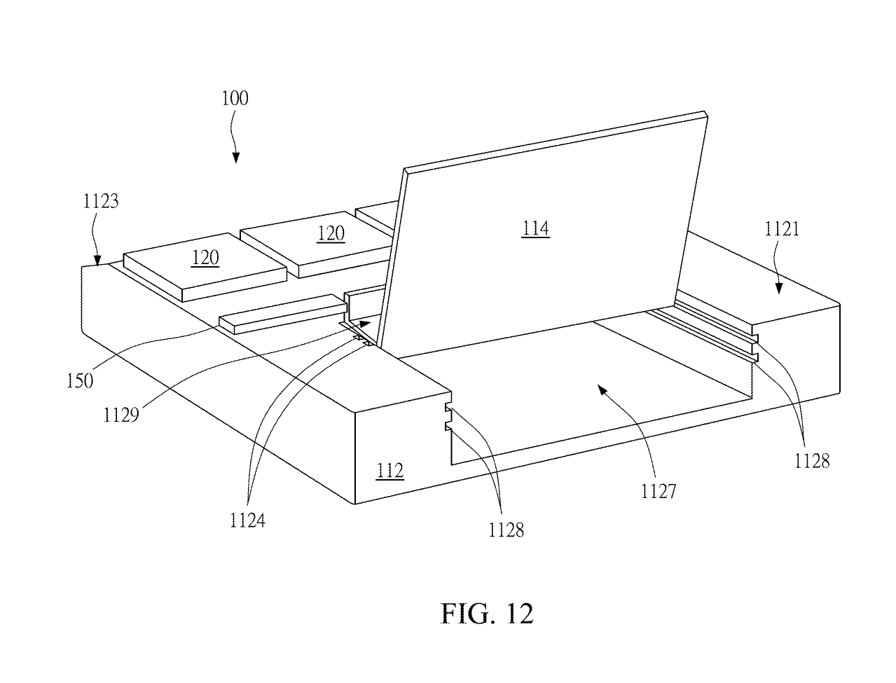

FIG. 11 is a schematic view for showing a game inputting device 100 of a fourth embodiment of the disclosure is in a receiving state. FIG. 12 is a schematic view for showing the game inputting device 100 of the fourth embodiment of the disclosure is in a working state.

The game inputting device 100 of the fourth embodiment is approximately similar to that of the third embodiment, except that the outlines and the shapes of the brackets 114 are different, the detail will be elucidated later.

As referring to FIG. 11 and FIG. 12, the bracket 114 is formed by connecting three plates, and the three plates form a receiving groove 1129. The handheld electronic-device 300 can be disposed in the receiving groove 1129 in the working state. Here, the body 112 has a fastening portion 1124, and the fastening portion 1124 is substantially a slot disposed on the two side walls of the breach 1127 of the rear side of the top plane 1121 of the body 112. The bracket 114 can be engaged into the slot (namely, the fastening portion 1124) to stand on the body 112.

As shown in FIG. 12, each of the two side walls of the breach 1127 further has a ditch 1128 parallel to the bottom of the breach 1127. Based on this, the bracket 114 is inserted along the ditch 1128 to cover the breach 1127 in the receiving state.

As shown in FIG. 12, the game buttons 120 can be isolated-style buttons and formed as rectangle shapes. Here, the game buttons 120 are disposed along the edge of the front side of the top plane 1121, and the body 112 has an inclined plane 1123 disposed on the edge of the front side.

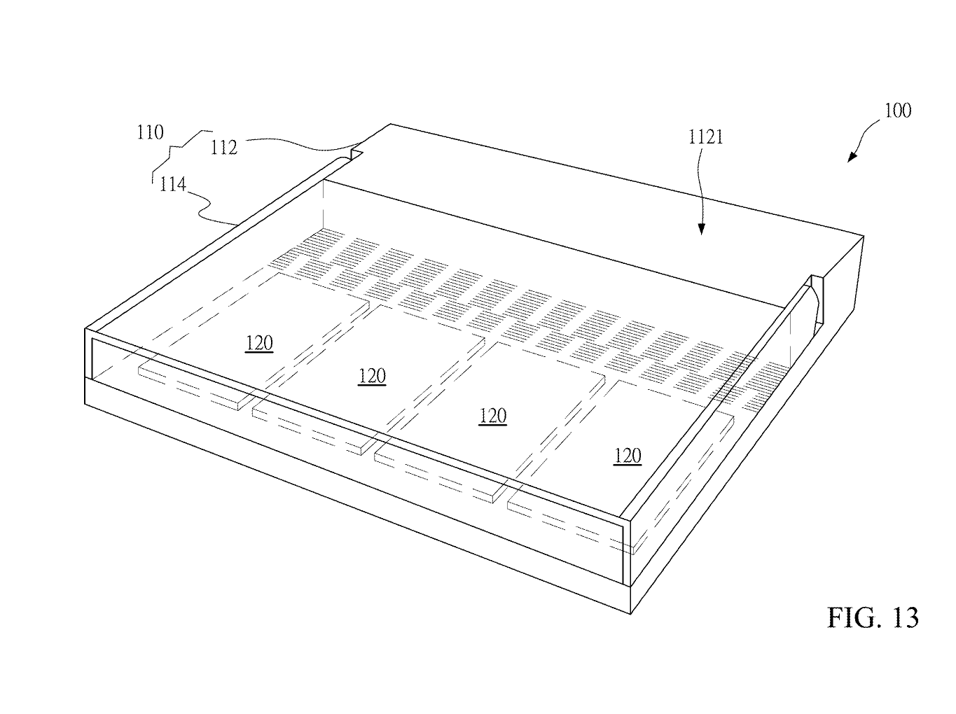

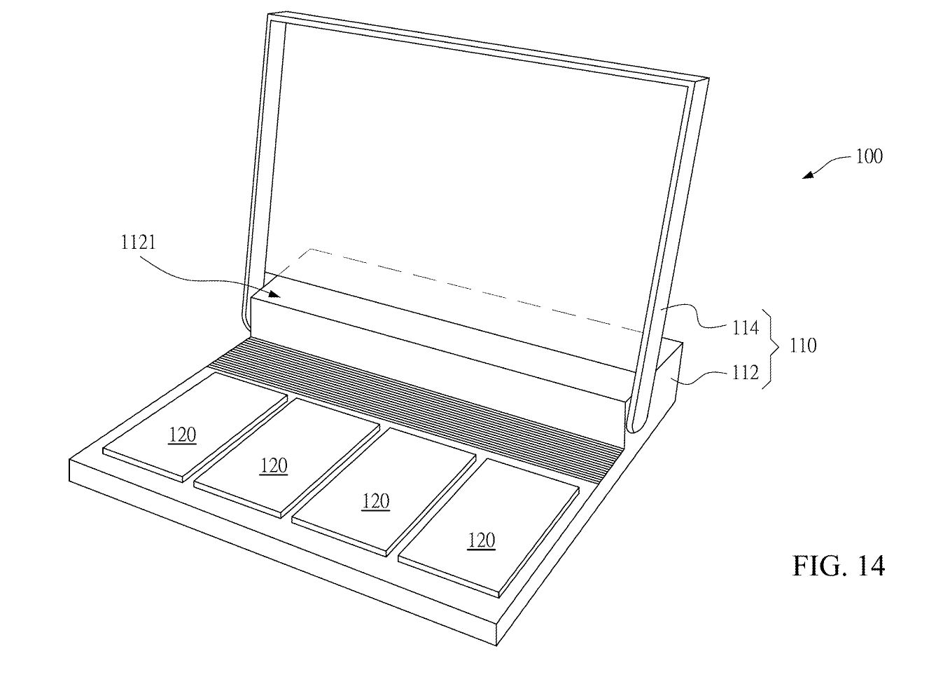

FIG. 13 is a schematic view for showing a game inputting device 100 of a fifth embodiment of the disclosure is in a receiving state. FIG. 14 is a schematic view for showing the game inputting device 100 of the fifth embodiment of the disclosure is in a working state.

The game inputting device 100 of the fifth embodiment is approximately similar to that of the first embodiment, except that the pivoting positions of the brackets 114 are different, the detail will be elucidated later.

As referring to FIG. 13 and FIG. 14, in the fifth embodiment, the bracket 114 is pivotally connected near the middle portion of the rear side of the body 112, but not being pivotally connected to the edge of the rear side of the body 112 as described in the first embodiment. Based on this, the bracket 114 covers on the body 112 in the receiving state; while the bracket 114 can be lifted so as to be abutted against by the top plane 1121 of the body 112 in the working state and forms an inclined angle with the top plane 1121. Based on this, the handheld electronic-device 300 can lean on the bracket 114 and stand on the top plane 1121.

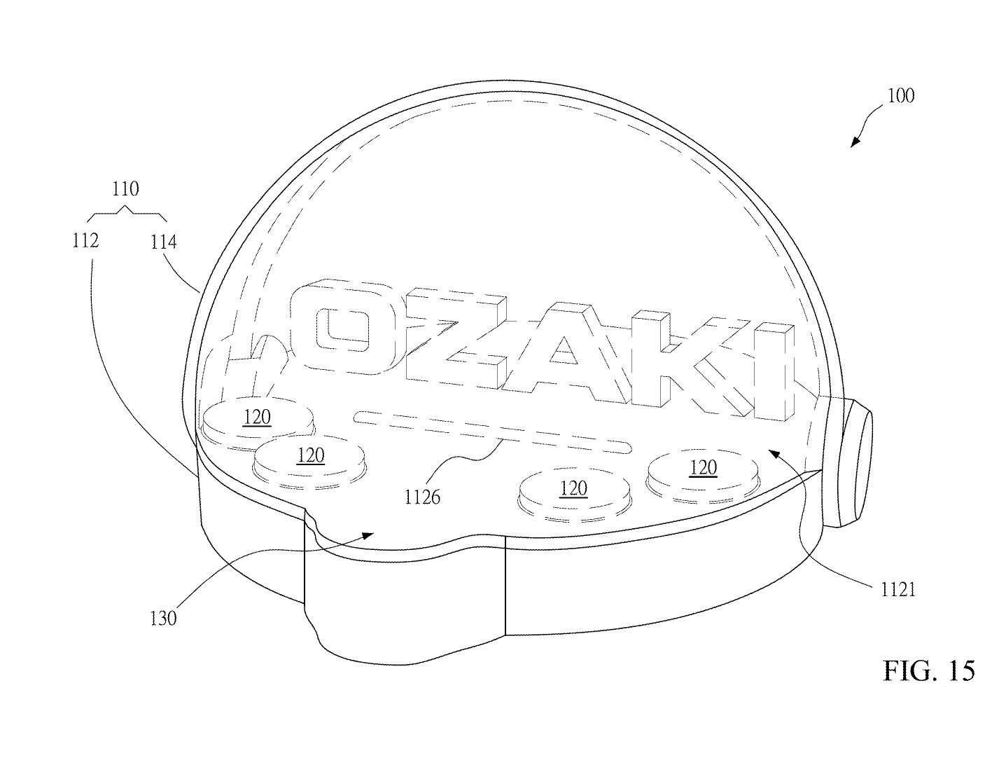

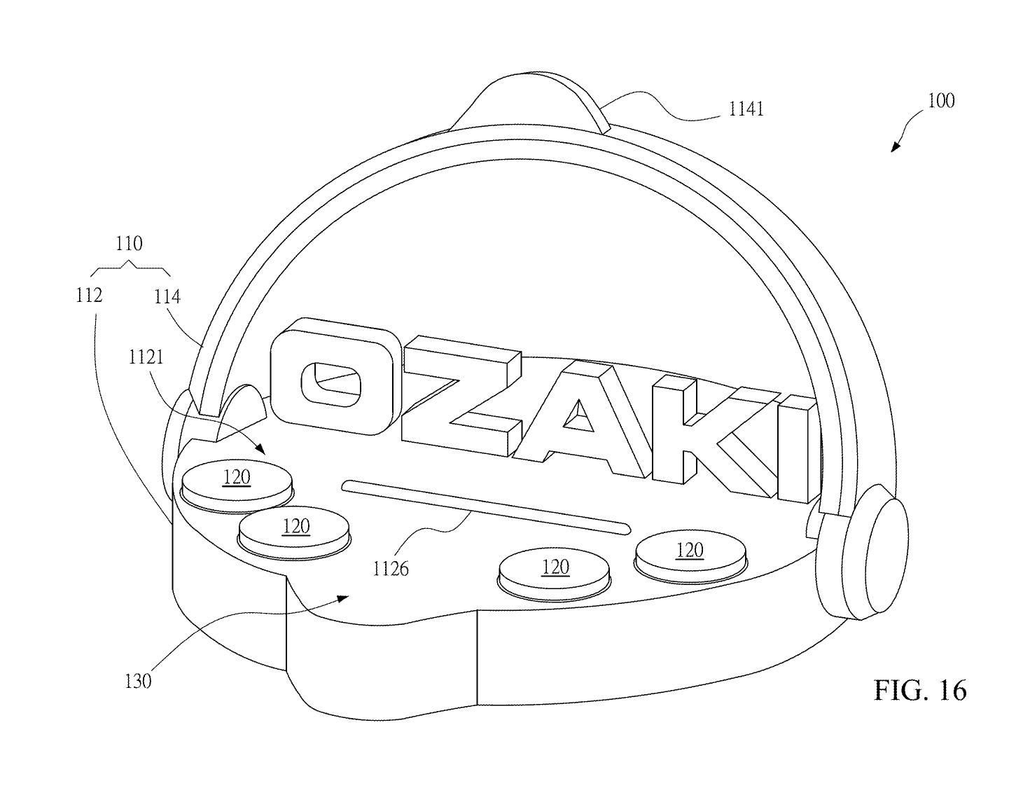

FIG. 15 is a schematic view for showing a game inputting device 100 of a sixth embodiment of the disclosure is in a receiving state. FIG. 16 is a schematic view for showing the game inputting device 100 of the sixth embodiment of the disclosure is in a working state.

The game inputting device 100 of the sixth embodiment is approximately similar to that of the fifth embodiment, except that the outlines of the bodies 112 and the brackets 114 are different, the detail will be elucidated later.

Please refer to FIG. 15 and FIG. 16, the outline of the bracket 114 is semi-spherical shaped. The bracket 114 covers the surface of the body 112 in the receiving state; while the bracket 114 is half-opened in the working state for standing the handheld electronic-device 300 on the game inputting device 100. Here, the base 110 further includes a skid-proof protruding rib 1126 disposed on the top plane 1121 of the body 112, and the skid-proof protruding rib 1126 prevents from the handheld electronic-device 300 moving on the body 112 freely. The top plane 1121 of the body 112 is quasi-circular shaped and a first protruding portion 130 is extended from one end thereof which is near to the game buttons 120. The bracket 114 has a second protruding portion 1141 corresponding to the first protruding portion 130, so that the user can lift up the bracket 114 by the first protruding portion 130 and the second protruding portion 1141 conveniently.

As shown in FIG. 16, the game buttons 120 can be respectively disposed on the two sides of the front side of the body 112, that is, can be respectively disposed on the two sides of the first protruding portion 130. Based on this, the user can operate the game buttons 120 with his/her two hands respectively.

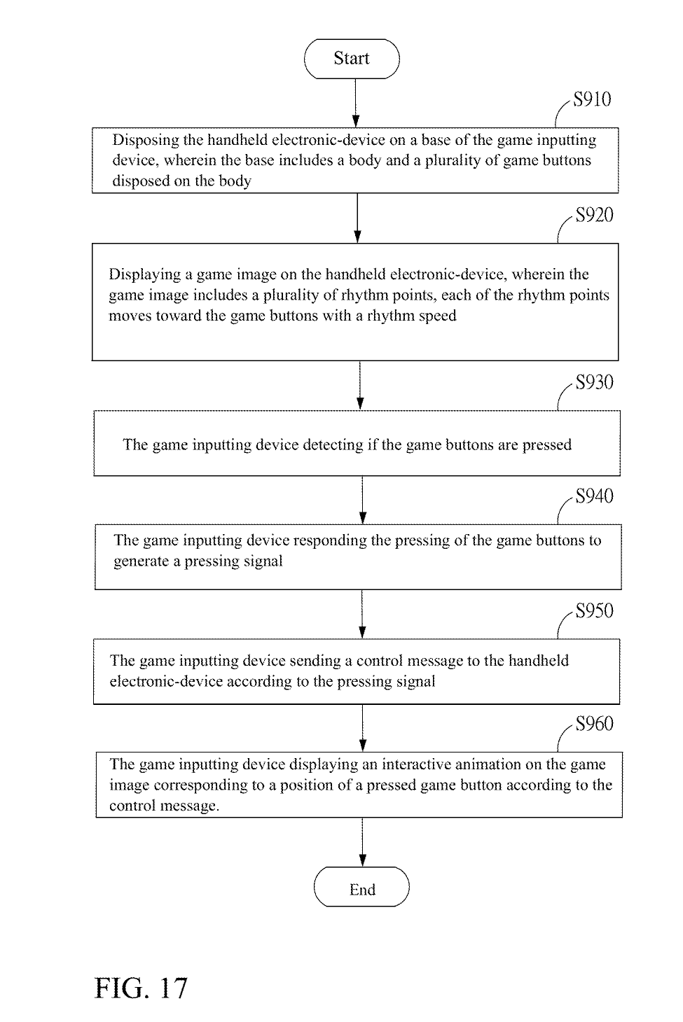

According to the description, the disclosure provides a game controlling method applicable for a handheld electronic-device 300 and a game inputting device 100. Please refer to FIG. 17, which is a flow chart of a game controlling method of one embodiment of the disclosure. The game controlling method includes the following steps.

Step S910: Disposing the handheld electronic-device 300 on a base 110 of the game inputting device 100. Here, the handheld electronic-device 300 can be disposed longitudinally or transversely based on the game software corresponding to.

Step S920: The handheld electronic-device 300 executing a game software (that is, an application program) to display a game image. The game image includes a plurality of rhythm points 540. Each of the rhythm points 540 is moved toward the game buttons 120 of the game inputting device 100 with a rhythm speed. Here, the game image further includes a plurality of rhythm tracks 520 in which the number thereof is corresponding to the number of the game buttons 120. The head terminal of each of the rhythm tracks 520 is far from the game buttons 120, and the tail terminal of each of the rhythm tracks 520 is near to the game buttons 120. Each rhythm point 540 is moved from the head terminal of each corresponding rhythm track 520 toward the tail terminal of each corresponding rhythm track 520. Here, besides executing the game software, the handheld electronic-device 300 can further output music simultaneously, and the rhythm points 540 can be generated and moved corresponding to the tempo of the music.

Step S930: The game inputting device 100 detecting if the game buttons 120 are pressed. Before the step S930, the handheld electronic-device 300 further includes a step of establishing a communication connection between the game inputting device 100 and the handheld electronic-device 300.

Step S940: The game inputting device 100 responding the pressing of the game buttons 120 to generate a pressing signal.

Step S950: The game inputting device 100 sending a control message to the handheld electronic-device 300 according to the pressing signal.

Step S960: The game inputting device 100 displaying an interactive animation 560 on the game image corresponding to the position of the pressed game button 120 according to the control message.

Here, before the step S930, the game controlling method further includes the steps as following. (A): Disposing the bracket 114 on the body 112 of the base 110 in a working state so as to support the handheld electronic-device 300 standing on the base 110. (B): Detachably covering the bracket 114 on the breach 1127 of the body 112 of the base 110 in a receiving state.

In one embodiment, in order to make the game image of the game software correspond to the game inputting devices 100 with different configurations of the game buttons 120, when the game inputting device 100 is linked to the handheld electronic-device 300, the communication module 140 of the game inputting device 100 can send a configuration message (including the number and the position of the game buttons 120) corresponding to the configuration of the game buttons 120 of the game inputting device 100 to the handheld electronic-device 300. Based on this, the game image of the handheld electronic-device 300 is adjusted according to the configuration message, so that the number of the rhythm tracks 520 of the game image is corresponding to the number of the game buttons 120, and the positions of the rhythm tracks 520 are corresponding to that of the game buttons 120 as well. Here, the configuration message can also be the model number of the game inputting device 100, and the handheld electronic-device 300 can figure out the configuration of the game buttons 120 according to the model number of the game inputting device 100 to generate a corresponding game image. When many users have the game inputting devices 100 with different configurations of the game buttons 120, they can exchange their game inputting devices 100 with each other, so that they can have different entertainments by the different game images upon playing the same game software.

As above, the game inputting device 100 and game controlling method of the disclosure enables the user to play the game conveniently, so that the screen 310 of the handheld electronic-device 300 is not shielded. Besides, the receiving state and the working state of the game inputting device 100 lead the game inputting device 100 to be carried and operated conveniently. Furthermore, the game inputting device 100 can notify the handheld electronic-device 300 of the configuration of the game buttons 120 actively, so that the game image displayed on the handheld electronic-device 300 can be adjusted properly according to the game inputting device 100.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A game inputting device, cooperating with a handheld electronic-device, the handheld electronic-device having a screen for displaying a game image, the game inputting device comprising:
a base, comprising body and a bracket disposed on the body, the bracket supporting the handheld electronic-device standing on the base in a working state;
a plurality of game buttons, disposing on the body of the base, the game image comprising a plurality of rhythm points, each of the rhythm points moving toward the game buttons with a rhythm speed;
a detection module, electrically connected to the game buttons and responding the pressing of the game buttons to generate a pressing signal; and
a communication module, sending a control message to the handheld electronic-device according to the pressing signal, wherein the handheld electronic-device displays an interactive animation on the game image corresponding to a position of the pressed game button according to the control message.

2. The game inputting device according to claim 1, wherein the body comprises a breach, the bracket is detachably covered on the breach in a receiving state.

3. The game inputting device according to claim 2, wherein the body comprises a fastening portion, the bracket is disposed on the fastening portion in the working state.

4. The game inputting device according to claim 1, wherein the bracket is pivotally connected to the body.

5. The game inputting device according to claim 1, wherein the game buttons are disposed at a front side of the body of the base, the bracket is disposed at a rear side of the body of the base in the working state, and the screen of the handheld electronic-device is faced to the game buttons in the working state.

6. The game inputting device according to claim 1, wherein the game buttons are disposed along an edge of the front side of the body of the base.

7. The game inputting device according to claim 1, wherein the game buttons are disposed along a parabola line, the opening of the parabola line is toward an edge of the front side of the body.

8. The game inputting device according to claim 5, wherein the body has an inclined plane disposed at the edge of the front side thereof.

9. The game inputting device according to claim 6, wherein the body has an inclined plane disposed at the edge of the front side thereof.

10. The game inputting device according to claim 7, wherein the body has an inclined plane disposed at the edge of the front side thereof.

11. The game inputting device according to claim 1, wherein each of the game buttons is closely disposed to the adjacent game buttons.

12. The game inputting device according to claim 1, wherein the number of the game buttons is four.

13. The game inputting device according to claim 1, wherein the communication module sends a configuration message corresponding to the game buttons to the handheld electronic-device, the handheld electronic-device displays the game image corresponding to the configuration message.

14. The game inputting device according to claim 1, wherein the game image further comprises a plurality of rhythm tracks, the number of the rhythm tracks is corresponding to the number of the game buttons, head terminals of the rhythm tracks are far from the game buttons respectively, tail terminals of the rhythm tracks are near to the game buttons respectively, each rhythm point is moved from the head terminal of each corresponding rhythm track toward the tail terminal of each corresponding rhythm track with the rhythm speed.

15. A game controlling method, applicable for a handheld electronic-device and a game inputting device, the game controlling method comprising:
disposing the handheld electronic-device on a base of the game inputting device, wherein the base comprises a body and a plurality of game buttons disposed on the body;
displaying a game image on the handheld electronic-device, wherein the game image comprises a plurality of rhythm points, each of the rhythm points moves toward the game buttons with a rhythm speed;
the game inputting device detecting if the game buttons are pressed;
the game inputting device responding the pressing of the game buttons to generate a pressing signal;
the game inputting device sending a control message to the handheld electronic-device according to the pressing signal; and
the game inputting device displaying an interactive animation on the game image corresponding to a position of a pressed game button according to the control message.

16. The game controlling method according to claim 15, further comprising:
disposing a bracket on the body of the base in a working state so as to support the handheld electronic-device standing on the base; and
detachably covering the bracket on a breach of the body of the base in a receiving state.
